(19) United States
(12) Patent Application Publication
(10) Pub. No.: US 2006/0289530 A1
(43) Pub. Date: Dec. 28, 2006

(54) Hideaway oven door

(76) Inventor: Anthony Cordae, Fort Lee, NJ (US)

Correspondence Address: HOFFMANN & BARON, LLP, 6900 JERICHO TURNPIKE, SYOSSET, NY, 11791, US

(21) Appl. No.: 11/403,593

(22) Filed: Apr. 13, 2006

Related U.S. Application Data
(60) Provisional application No. 60/671,927, filed on Apr. 15, 2005.

(51) Int. Cl. H05B 6/64

(52) U.S. Cl. 219/756

(57) ABSTRACT

An oven having a retractable hideaway door comprising an oven body, an oven door hingedly connected to the oven body, a cavity in the oven body adapted to receive the oven door, and a slide device for moving the oven door into the oven body when it is in the fully opened position.

### CROSS-REFERENCE TO RELATED APPLICATIONS

This application claims the benefit of U.S. Provisional Application No. 60/671,927 filed on Apr. 15, 2005, entitled “Hideaway Oven Door”.

### FIELD OF THE INVENTION

The present invention relates generally to an oven door and related mechanism for opening and closing the door as well as sliding the door into a cavity in the oven housing when the door is in an open position.

### BACKGROUND OF THE INVENTION

Typically oven doors are hinged at the bottom and opened by pulling the top of the door such that the door rotates on its hinges. Once the door is open this presents a problem in that the door prevents easy access to the oven. In the case of a wall oven, the user must stand a distance away from the oven to place or remove items from the oven. In the case of a range type oven, the difficulty is increased further due to the low height of the oven as well as the long door, which causes the user to stand a significant distance from the oven. In addition, due to the low height of a range type oven the open door present a significant safety risk since the hot surface is within the reach of children who may be present.

### SUMMARY OF THE INVENTION

The present invention provides an over door that can not only be pivoted on its hinges thereby allowing access to the oven. In addition, the door is mounted on a slide mechanism, such that when the door is fully open, the slide mechanism is engaged and the door can be slid into a cavity in the oven body or housing. Therefore, the user can get closer to the oven in order to perform various task associated with cooking. In addition, it is easier for the user to place and remove items in the oven. Furthermore, the hot oven door is retracted out of the way, thereby removing a safety hazard since the user does not need to reach over a hot surface.

Therefore there is provided an a oven having a retractable hideaway door comprising an oven body, an oven door hingedly connected to the oven body, a cavity in the oven body adapted to receive the oven door, and a slide device for moving the oven door into the oven body when it is in the fully opened position.

### BRIEF DESCRIPTION OF THE DRAWINGS

FIG. 1 shows a perspective view of an oven incorporating a hideaway door according to the present invention.

FIG. 2 is a cut away side view of an oven incorporating a hideaway door according to the present invention.

FIG. 3a is a top view of an oven incorporating a hideaway door according to the present invention.

FIG. 3b is a front view of an oven incorporating a hideaway door according to the present invention.

FIG. 3c is a perspective view of an oven incorporating a hideaway door according to the present invention.

FIG. 3d is a side view of an oven incorporating a hideaway door according to the present invention.

FIG. 4a is a cut away side view of an oven incorporating a hideaway door according to the present invention.

FIG. 4b is a top view of an oven incorporating a hideaway door according to the present invention.

FIG. 4c is a perspective view of an oven incorporating a hideaway door according to the present invention.

FIG. 4d is an exploded view of the roller bearing and slide mechanism for the oven hideaway door according to the present invention.

### DETAILED DESCRIPTION OF THE PREFERRED EMBODIMENT:

The present invention provides an oven door that is hingedly attached to an over body such that it can swing open in the typical manner. In the usual arrangement, the oven door is hinged at the bottom and pivots downward, although other alternate arrangements are possible, such as for example having the door hinged at the side and opening to the left or right. In addition the present invention incorporates a slide mechanism which, when the door is fully opened allows the door to be pushed into a cavity in the oven. In that way the oven door is hidden away into the oven. The door can be mounted on a variety of slide mechanisms known in the art, which enable the oven door to be pushed into a cavity in the oven. By sliding the door into a cavity that is adapted to receive the door, it is removed as an obstacle for the user thereby increasing the safety and the ease of use of the oven.

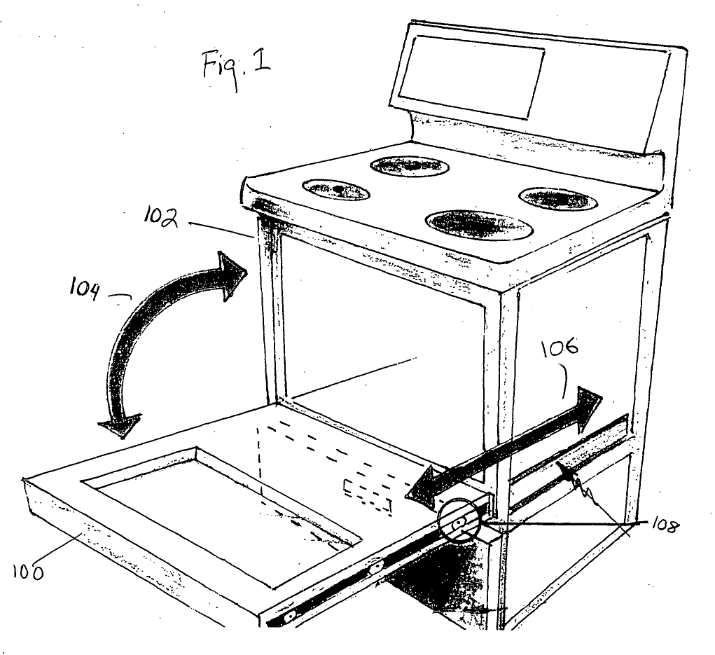

Turning now to FIG. 1, there is shown a perspective drawing of the oven door 100 according to the current invention. Shown is an oven body 102 with the oven door 100 in a fully opened position. There are arrows denoting the door range of motion in both the rotational 104 frame of reference and the translational 106 frame of reference. As shown in the fully opened position, the door 100 can be moved along a track in the oven body (not shown in this view) on rollers or bearings 108 mounted on the oven door.

More specifically when the oven door 100 is fully opened, the rollers or bearings 108 are placed in alignment with a track mounted on the inside of oven body 102. Once in alignment with the track, the rollers or bearings are free to slide along that track, and thereby move the oven door 100 inside the oven body 102. It should be noted that of course the oven door width dimension is somewhat smaller that the interior width dimension of the oven body 102, thus the oven door 100 can slide into the oven body 100.

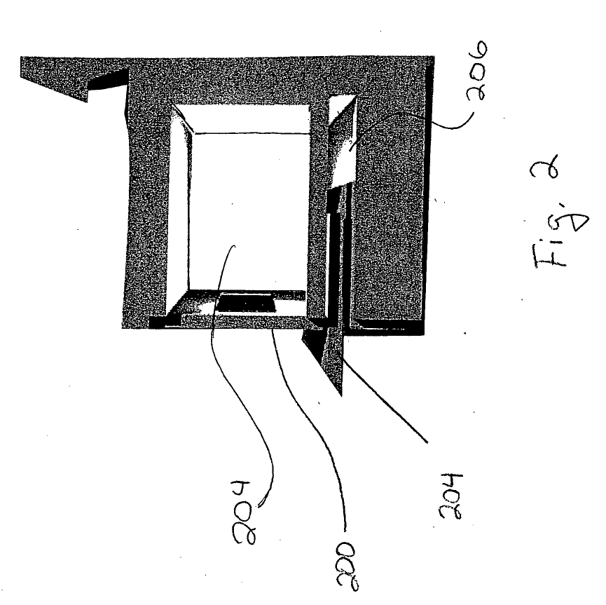

FIG. 2 shows a side cutaway view of the hideaway oven door 100 according to the present invention, showing a representation of the door 100 as it would be in both the upright closed position 200, and the fully opened and retracted position 204 within the oven body 102 cavity. In this view, one can see the that the oven body 102 is adapted to receive the oven door 100 within the oven body 102. In accordance with the present invention, the oven body is adapted to receive the oven door 100 by including a track on which rollers or bearings 108 of the oven door 100 can glide when the oven door 100 is placed in alignment with the track. The track can alternately be mounted within the primary cavity 204 of the oven body 102 where food is usually prepared or a separate cavity 206 can be included in the oven body 102 design that is adapted to receive the oven door 100 by the inclusion of the track for receiving the bearings or rollers 108 of oven door 100. By including the additional cavity 206 the primary oven cavity 204 need not have a track or have part of its interior volume set aside to receive the oven door 102.

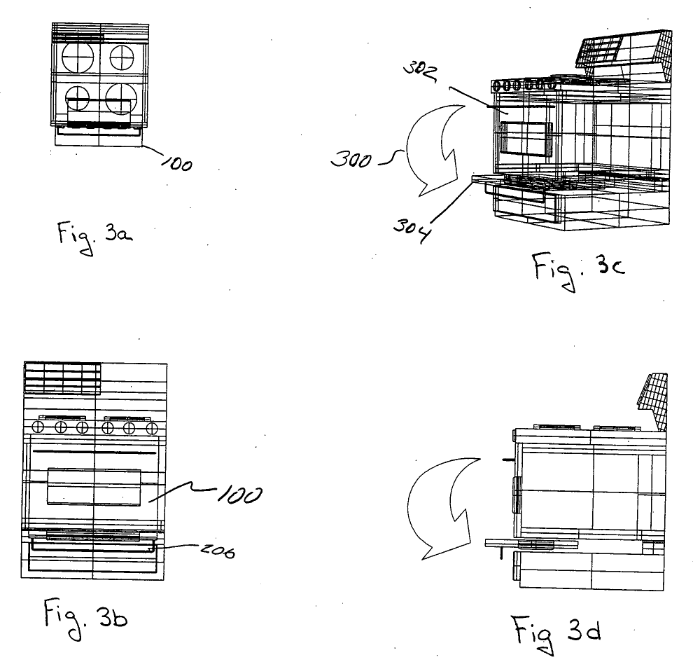

FIG. 3a shows a top view of the oven in accordance with the present invention. In this view the oven is typical of ovens of this type of range oven. It should be noted here, that while the oven door 100 of the present invention is depicted in this description in use with a range type oven. Alternate embodiments are also contemplated and are within the scope of the invention, including wall type ovens. Turning again to FIG. 3a, the top of door 100, which is in the open retracted position, can be seen protruding from the front of oven body 102. In this view, as will be further described with respect to FIGS. 3b-3d, it is apparent that door 100 has been rotated into the fully open position, and then retracted into the oven body 102, thereby leaving only the top portion of door 100 protruding from oven body 102. It can thus be seen in this view that the oven door 100 is minimized as an obstruction for a user in accessing the oven interior to place or remove items for cooking since the user can approach the oven more closely and does not need to reach over the oven door 100 to place items within the oven. This can be especially useful for those with limited reach or strength when handling large or heavy object.

FIG. 3b shows a front view of the oven according to the present invention showing the oven door as well as the front view of the cavity, which is adapted to accepting the door when it is in a fully opened position. In the view shown the oven door 100 is shown fully closed. Visible below door 100 is cavity 206, which is adapted to receive the oven door after it has been rotated into the open position.

FIG. 3c shows a representation of the oven door according to the present invention in a perspective view showing a representation of the door in both the upright closed position, and the fully opened and retracted position within the oven body cavity, with an arrow to denote the rotational motion of the oven door. Arrow 300 shows the direction of rotational motion of the oven door as it moves from the fully closed postion, 302 to the open position, and thereafter into the retracted position 304. In this view the door 100 in the retracted position only the top portion of door 100 protruding from oven body 102. Therefore, the oven door 100 is minimized as an obstruction for a user in accessing the oven interior to place or remove items for cooking since the user can approach the oven more closely and does not need to reach over the oven door 100 to place items within the oven. This can be especially useful for those with limited reach or strength when handling large or heavy object.

FIG. 3d shows a side view of the oven door according to the present invention in a perspective view showing a representation of the door in both the upright closed position, and the fully opened and retracted position within the oven body cavity, with an arrow to denote the rotational motion of the oven door. Arrow 300 shows the direction of rotational motion of the oven door as it moves from the fully closed postion, 302 to the open position, and thereafter into the retracted position 304. In this view the door 100 in the retracted position only the top portion of door 100 protruding from oven body 102. Therefore, the oven door 100 is minimized as an obstruction for a user in accessing the oven interior to place or remove items for cooking since the user can approach the oven more closely and does not need to reach over the oven door 100 to place items within the oven. This can be especially useful for those with limited reach or strength when handling large or heavy object.

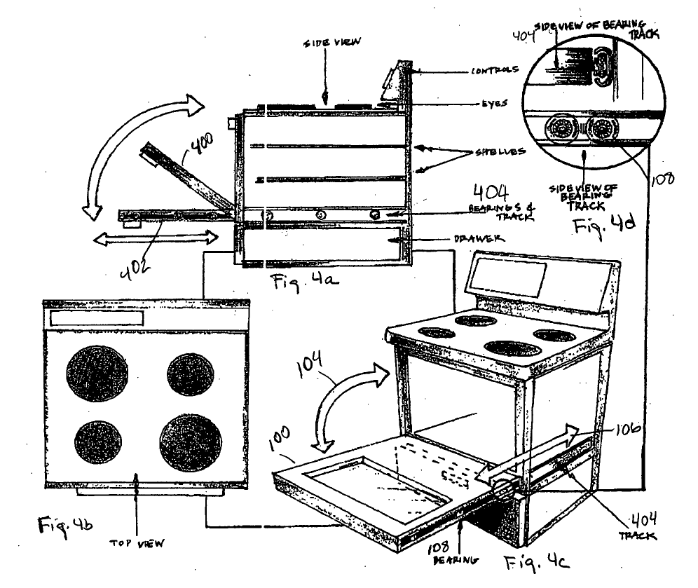

FIG. 4a shows a side cutaway view of the slideaway oven door according to the present invention, showing a representation of the door in both a semi open position 400 and a fully open position 402 with the roller or bearings 108 for sliding and positioning door 100 along track 404 as well arrows denoting the motion of the oven door 100 in the rotational 104 frame of reference and the translational 106 frame of reference. It should be noted that the oven door 100 of the present invention can be mounted on a variety of hinges to allow rotational motion of the door about the hinges as well as translational motion of the door when it is in the fully open position. A non-limiting example may be found in U.S. Pat. No. 7,000,977 which is incorporated herein by reference in its entirety. However as seen in the more detailed view of FIG. 4d, the oven door 100 will also include rollers or bearings 108 mounted to the side of the door 100 which are brought into alignment with track 404 when door 100 is rotated into the fully open position. Once the door is rotated into the fully open position the hinges attached to door 100 will allow the door to translate from the extended position to the fully retracted position. This can be accomplished by mounting the hinge itself on rollers or bearing that can slide or translate on track 404. In that way, once the door is fully opened, the entire hinge assembly can move along the track 404 to retract door 100. When door 100 is in the fully extended position, the hinge is free to allow rotational motion of door 100.

FIG. 4b shows a top view of the oven in accordance with the present invention. In this view the oven is typical of ovens of this type of range oven.

FIG. 4c shows a representation of the oven door according to the present invention in a perspective view showing a representation of the door 100 in the fully opened and extended position outside the oven body cavity and with the roller bearing slide track with arrows to denote the rotational 104 frame of reference and the translational 106 frame of reference. In the fully open and extended position, the rollers or bearings are brought into alignment with track 404, thereby the hinge as previously described and the door 100 can then be retracted into oven body 102 by exerting a force on the oven door 100 to push the door into the oven body 102.

FIG. 4d shows a detail view of the roller bearing slide track for translational movement of the door according to the present invention. In this described embodiment, round rollers are affixed to door 100 on a spindle which allows for the rollers to rotate about the spindle and thereby assist in moving the door 100 into the oven body 102 by supporting door 100 on track 404. When the door 100 is pushed into the oven, the roller will rotate on track 404. It should be pointed out that various mechanisms known in the art could be used including but not limited to for example, nylon, (or other low friction materials) slides or ball bearing slides to provide a low friction surface for allowing door 100 to be easily moved within oven body 102. It should be further noted that any such material will be suitable to the high temperature environment of an oven.

It should further be pointed out that the present invention can be adapted to ovens of various types including ranges and wall ovens, or other ovens known to one skilled in the art.

While the invention has been described in related to the preferred embodiments with several examples, it will be understood by those skilled in the art that various changes may be made without deviating from the fundamental nature and scope of the invention as defined in the appended claims.

What is claimed is:

1. An oven having a retractable hideaway door comprising an oven body, an oven door hingedly connected to said oven body to move between an open and closed position, a cavity in said oven body adapted to receive said oven door, and a slide device for moving said oven door into said oven body when it is in said opened position.
